(19) United States
(12) Patent Application Publication
(10) Pub. No.: US 2025/0019018 A1
(43) Pub. Date: Jan. 16, 2025

(54) DEBRIS DEFLECTION DEVICE AND USE THEREOF

(71) Applicants: Elena A. Willoughby, Warren, OH (US); Robert Earl Baumann, New Florence, PA (US); Robert Phillip Baumann, Lower Burrell, PA (US)

(72) Inventors: Elena A. Willoughby, Warren, OH (US); Robert Earl Baumann, New Florence, PA (US); Robert Phillip Baumann, Lower Burrell, PA (US)

(21) Appl. No.: 18/771,810

(22) Filed: Jul. 12, 2024

Related U.S. Application Data
(60) Provisional application No. 63/526,891, filed on Jul. 14, 2023.

(51) Int. Cl. B62D 55/088; B62D 55/06; B62D 55/10; B62D 55/30

(52) U.S. Cl. CPC B62D 55/088; B62D 55/06; B62D 55/10; B62D 55/30

(57) ABSTRACT

A vehicle system that includes a main frame with an at least one track configured to facilitate movement of a tracked vehicle. There is a track frame associated with the main frame and proximate to a set of hubs. The track frame includes an outer track frame portion and an inner track frame portion, with a debris deflection device coupled one or both of the outer track frame portion and the inner track frame portion.

### BACKGROUND

### Field of the Disclosure

Industrial off-road or other terrain-type vehicles (e.g., tractors, harvesters, combines, loaders, excavators, bulldozers, tree chippers, snowmobiles, all-terrain vehicles (ATVs), garbage trucks, tanks, etc.), are used on soft, slippery, and/or irregular grounds for work and/or other purposes. The type of surface may be dynamic and change over time, such as from hard to muddy, and one or more types of debris may be encountered, such as: dirt, soil, mud, sand, snow, garbage, entrained matter, etc., and combinations thereof. To enhance traction and maneuverability, such vehicles are known to be equipped with track systems.

The operation and use of such vehicles is not without issue. With nearly unanimous frequency, operators are required to divert resources (including sometimes significantly) for the cleaning, stalling, and site shutdowns when the vehicle track system becomes packed with dirt and debris. Due to such conditions, the vehicle is often inoperable, requiring attention and maintenance accounted for as ‘downtime’.

Downtime includes a minor shutdown to a total shutdown of project operation or work site, which is costly. Operators may be trained to drive vehicles but are often resultantly tasked to clean or free the debris, mud, or dirt from the vehicles' tracks. This can be a lengthy process as well as dangerous. When the operators are cleaning, they are not moving dirt (or other materials) as is their intended job. Often times work sites do not carry or possess the correct equipment to remove the dirt. And, asking people like a trained driver, who may not be trained to do vehicle maintenance, is full of inherent risk (including danger to personnel and equipment).

There is a need in the art to mitigate or eliminate downtime, and the need for operators to perform a task for which he/she is untrained.

### SUMMARY

Embodiments of the disclosure pertain to a debris deflector device for particular use with a (tracked) vehicle, which may be applicable in a number of industries, such as oil and gas, and the like.

Embodiments of the disclosure may be for any number of vehicles or other types of movers, such as any type of tracked vehicle, which may include one or more of: a main frame (body, chassis, etc.); and an at least one track configured to facilitate movement of the vehicle.

The vehicle may include any number of hubs or other type of rotating member, any or all of which may be operable coupled with the main frame (such as through suspension, transmission, other conventional coupling, etc.). One or more of the hubs may be powered, passive, and combinations thereof. As such, the hubs may be configured for engagement and movement (e.g., looping rotation) of the at least one track.

There may be a track frame associated with the main frame. The track frame may be an area (structure) of the main frame in proximity of the track. The track frame may have an outer track frame portion and an inner track frame portion, which may be of an elongated nature along a longitudinal of the vehicle.

There may be a debris deflection device coupled with the main frame, such as at or with the track frame. The debris deflection may include an inner panel or side and an outer panel or side. The panels may be integral or coupled together. The panels may be solid body. The panels may be configured and constructed to accommodate a telescoping or sliding panel. Thus, at least one of the inner panel and the outer panel may include a telescoping panel movably coupled therewith.

The inner panel may have a bottom inner panel end coupled with the inner track frame portion. In the same or similar manner, the outer panel may have a bottom outer panel end coupled with the outer track frame portion.

The inner panel may have a top inner panel end, and the outer panel may have a top outer panel end. In aspects, the top inner panel end and the top outer panel end may be engaged together to form a device crest. The device crest may extend end-to-end along a length of the device.

In operation of the vehicle, the at least one track may include at any given moment in time an upper track portion and a lower track portion. At this moment, the device crest may be proximate the upper track portion. Another way to consider is that the device crest may be oriented upward.

There may be at least one of a tensioner piston, a sprocket, an idler, other vehicle equipment, and combinations thereof, disposed within the track frame (such as between the set of hubs). This component(s) may be underneath the debris deflection device, whereby any debris falling downward is diverted or deflected away by the device.

The vehicle system may include any number of additional debris deflection devices. In aspects, the vehicle may include a second track (which may be configured to facilitate movement of the vehicle). There may be a second set of hubs operably coupled with at least one of an another side of the main frame, the first set of hubs (such as via an axle), and combinations thereof. The second set of hubs may be configured for engagement and movement of the second track.

There may be a second track frame associated with the main frame and proximate to the second set of hubs. There may be a second debris deflection device coupled with the second track frame.

These and other embodiments, features, and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1A shows a side view illustration of a vehicle system configured with a debris deflector device according to embodiments of the disclosure;

FIG. 1B shows a side exterior view of a debris deflector device according to embodiments of the disclosure;

FIG. 1C shows a rotated side exterior view of the debris deflector device of FIG. 1B according to embodiments of the disclosure;

FIG. 1D shows another side view of the debris deflector device of FIG. 1B according to embodiments of the disclosure;

FIG. 1E shows a simplified lateral sectional view of a vehicle system having a debris deflector device according to embodiments of the disclosure;

FIG. 1F shows a longitudinal side view of a vehicle system having an interior panel of a debris deflector device according to embodiments of the disclosure;

FIG. 1G shows a split front view of a vehicle having one or more debris deflector devices according to embodiments of the disclosure;

FIG. 2A shows a simplified schematic view of a panel for use with a debris deflector device according to embodiments of the disclosure;

FIG. 2B shows a simplified schematic view of another panel for use with a debris deflector device according to embodiments of the disclosure; and

FIG. 2C shows a side cross-sectional view of a debris deflector device according to embodiments of the disclosure.

### DETAILED DESCRIPTION

Regardless of whether presently claimed herein or in another application related to or from this application, herein disclosed are novel apparatuses, units, systems, and methods that pertain to improved operation of a vehicle (which may be tracked), details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and case of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, piping, and so forth. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical, or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

### Terms

The term “connected” as used herein may refer to a connection between a respective component (or subcomponent) and another component (or another subcomponent), which may be fixed, movable, direct, indirect, and analogous to engaged, coupled, disposed, etc., and may be by screw, nut/bolt, weld, and so forth. Any use of any form of the terms “connect”, “engage”, “couple”, “attach”, “mount”, etc. or any other term describing an interaction between elements is not meant to limit the interaction to direct interaction between the elements and may also include indirect interaction between the elements described.

The term “engine” as used herein may refer to a machine with moving parts that converts power into motion, such as rotary motion. The engine may be powered by a source, such as internal combustion.

The term “motor” as used herein may be analogous to engine. The motor may be powered by a source, such as electricity, pneumatic, or hydraulic.

The term “utility fluid” as used herein may refer to a fluid used in connection with the operation of a heat generating device, such as a lubricant or water. The utility fluid may be for heating, cooling, lubricating, or other type of utility. ‘Utility fluid’ may also be referred to and interchangeable with ‘service fluid’ or comparable.

The term “mounted” as used herein may refer to a connection between a respective component (or subcomponent) and another component (or another subcomponent), which may be fixed, movable, direct, indirect, and analogous to engaged, coupled, disposed, etc., and may be by screw, nut/bolt, weld, and so forth.

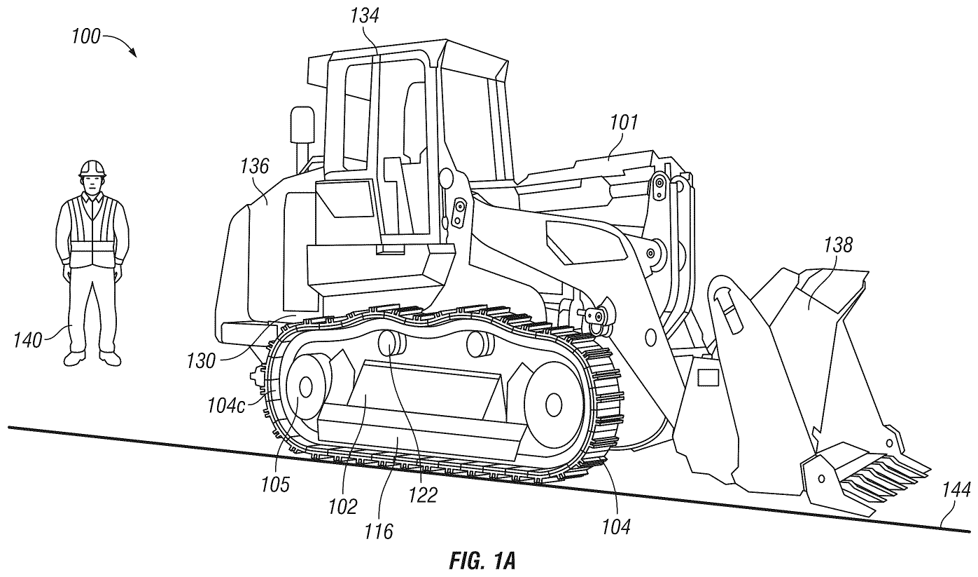

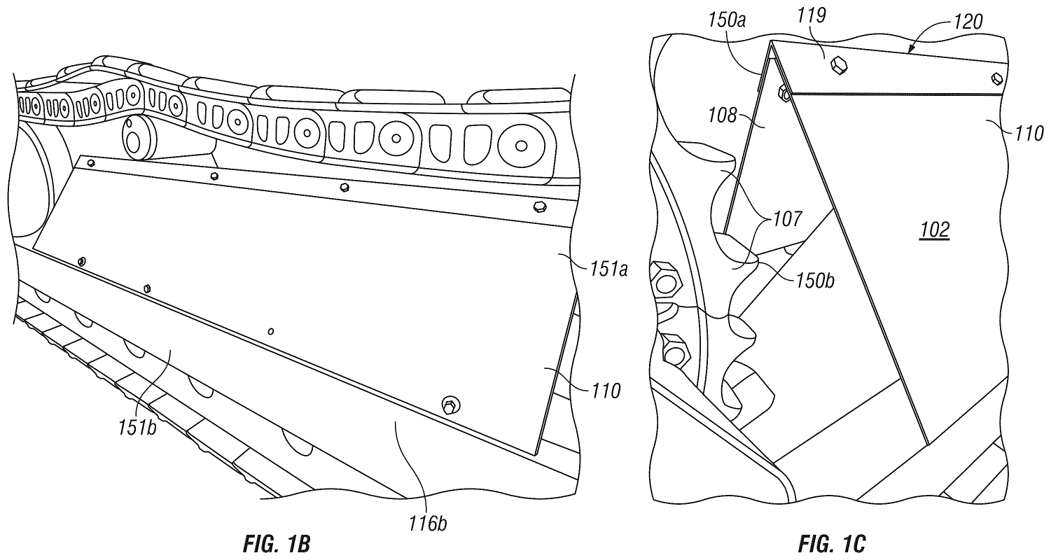

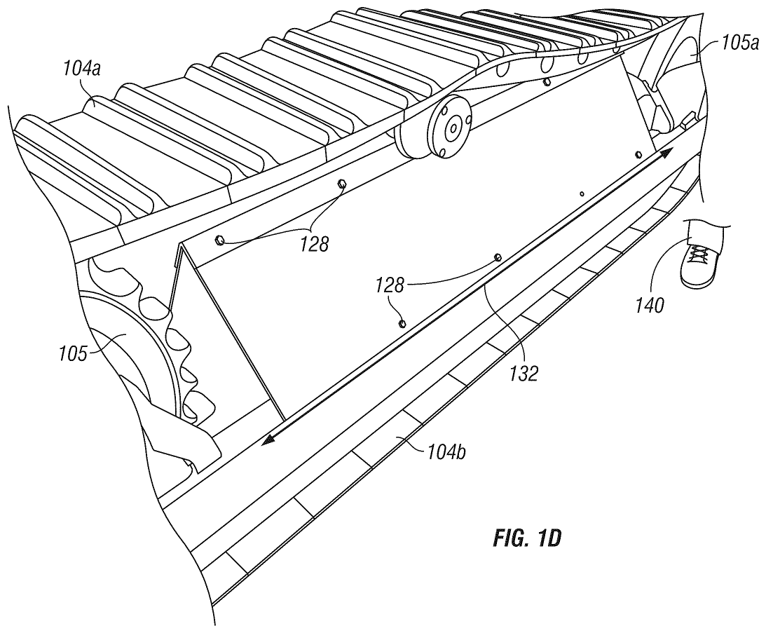

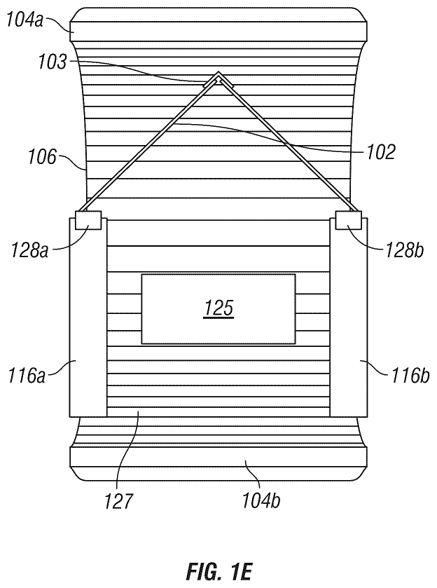

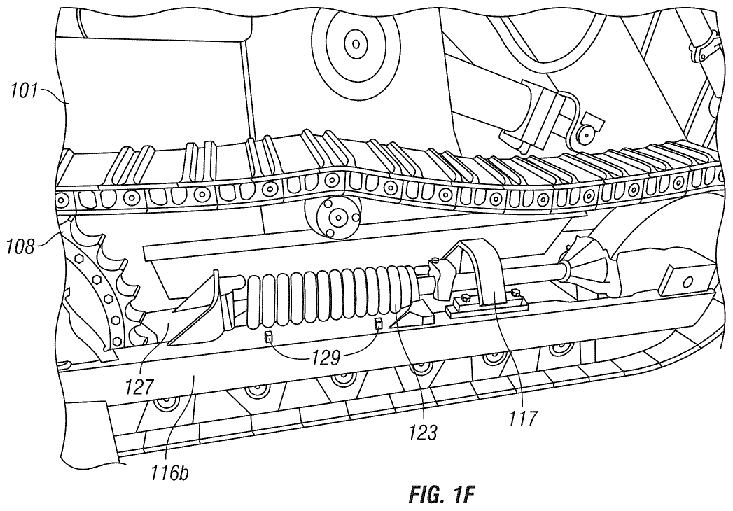

Referring now to FIGS. 1A, 1B, 1C, 1D, 1E, 1F, and 1G together, a side view illustration of a vehicle system configured with a debris deflector device, a side exterior view of a debris deflector device, a rotated side exterior view of the debris deflector device, another side view of the debris deflector device, a simplified lateral sectional view of a vehicle system having a debris deflector device, a longitudinal side view of a vehicle system having an interior panel of a debris deflector device, and a split front view of a vehicle having one or more debris deflector devices, respectively, illustrative of embodiments disclosed herein, are shown.

FIGS. 1A-1G together illustrate an embodiment of a vehicle system 100, which may have a wide variety of applications. Generally, the vehicle system 100 is not limited to any particular size, dimension, scale, material of construction, and other properties, such that its use is vast (and may include new or retrofit).

The system 100 may include a vehicle or other suitable powered unit 101, which may be a tracked vehicle. The vehicle 101 may include a main frame or chassis 130, which may be suitable for the support or operable connection with other components or devices, such as an operator cab or station 134.

The operation of the vehicle 101 may be directly accomplished by an operator 140. although other remote or robotic (drone, A.I., etc.) functions may be possible. The operation may be facilitated by a power unit or driver 136. For example, the vehicle 101 may have a combustion engine or battery. as would be apparent to one of skill in the art.

The operator cabin 134 may be where the operator 140 sits or otherwise controls the vehicle 101. The cabin 134 may be outfitted with a user interface (not shown here) which may be operably configured to allow the operator 140 to steer or move the vehicle 101. The vehicle 101 may be configured with suitable linkage (mechanical, electrical, hydraulic, combinations thereof, etc.) to provide operation and movement of a track (system) 104, as well as a load or driver device 138. The load device 138 may be, for example, a blade, a basket, forks, crane, etc. Although not shown here, it would be apparent that the vehicle 101 may have another or opposite side configured with another track.

The vehicle 101 may include a powertrain, a steering mechanism, a suspension, and other conventional aspects (not shown or discussed in detail here) that enable the operator 140 to function and move the vehicle 101 for the desired operation. The vehicle 101 may include one or more hubs 105 (sometimes ‘final drive’ or other form of powered rotating member) suitable for rotating a track 104 or other comparable component for moving the vehicle 101. The hub 105 may be associated with a geared or toothed member 107 that engages the track 104 for causing movement and rotation thereof.

At a static moment in time the track 104 may have an upper portion 104a and a lower portion 104b, as well as an engaged portion 104c. The movement of the vehicle 101 may correspond to the movement of the track 104 (such as in a loop) whereby the upper portion 104a rotates to become the lower portion 104b, and vice versa. The track 104 may be useful to move the vehicle 101 over a surface 144.

The surface 144 may be irregular or unimproved and thus be or include dirt, mud, etc. and other type of undesired material or ‘debris’ 106, whereby debris 106 may begin to collect and accumulate within or on the track 104.

The vehicle 101 may have a debris deflector device 102 coupled therewith, which may be useful to divert, deflect, etc. the debris 106 (see FIG. 1E). For example, as the track 104 rotates, the lower portion 104b may have debris 106 attach therewith, and upon further rotation the lower portion 104b may become the upper rotation 104a. Instead of the debris 106 falling (such as via shaking or gravity) into hub area or track well 127, the debris 106 is deflected.

The main frame 130 may have, include, or be associated with a track frame 116. The track frame 116 may be suitable or sufficient structure to support the operation and weight of components desired or necessary to operate and drive the track 104. The construction or configuration of the track frame 116 may provide for the track well 127, which may have one or more track components 125 (shown generically. FIG. 1E) arranged or disposed therein, such as an idler, roller 122, (tensioner) piston 123, or the like.

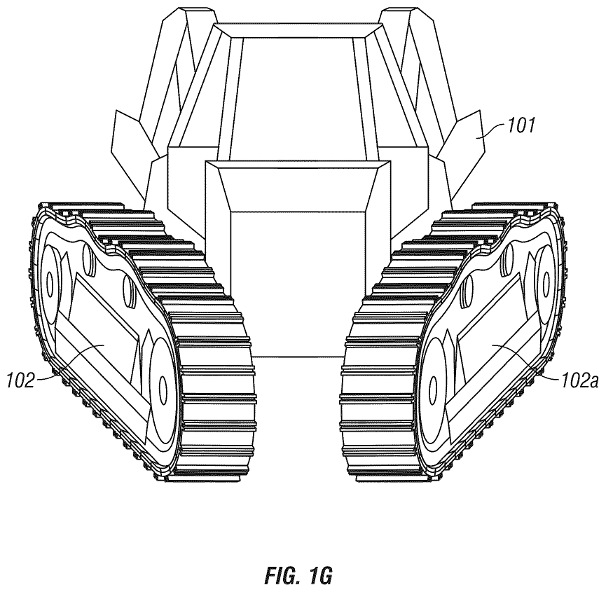

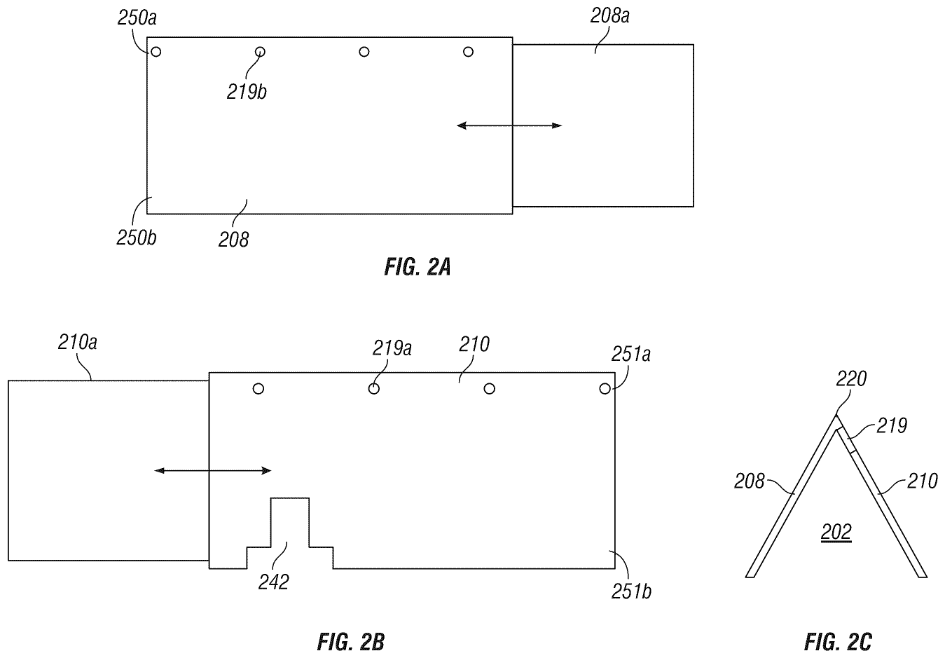

The debris deflector device 102 may be just that—a device (or assembly, component(s), etc.) suitable to deflect, move, urge, etc. debris 106 away from the area or region of the track well 127 (and any components 125 disposed or arranged therein). The device 102 may have a first or inner (side) panel 108, as well as a second or outer (exterior side) panel 110. The panels 108, 110 may be integral or coupled together, such as at a panel coupling point(s) (219, FIG. 2C).

The panels 108, 110 may have one or more fasteners or securing members 128. The panels 108, 110 may have respective mating features (219a, 219b) suitable to couple together to form a crest 120. The crest 120 may be elongated along a length of the device 102. Bolts or other suitable fasteners 128 may be used to couple the panels 108, 110 together.

The length of the device 102 may be at or less than a track frame length 132, which may extend between the hubs 105, 105a. Either or both of the panels 108, 110 may be configured with a respective movable or telescoping panel (208a, 210a), which may facilitate using the device 102 when the vehicle 101 has a varied or non-standard track frame length 132.

Embodiments herein provide for the debris deflector device (or assembly) 102, or related vehicle (system) 100, method of use, etc. whereby the device 102 may be configured for universal new or retrofit use to heavy machinery or other track vehicles (bulldozers, etc.) that deal with irregular surfaces that may include debris therewith. The device 102 may be universally fitted (adjusted) to any suitable vehicle 101, which may be accomplished by one or more panels 108, 110 configured with a sliding or moving (telescoping) panel. As such, the panels 108, 110 may have suitable structure to accommodate the sliding/telescoping movement.

The vehicle 101 may include the main frame 130, which may be of any durable type material, such as hardened steel. To that end, any or all components of the vehicle 101 may be of a durable material (metals, alloys, composites, etc.). The vehicle 101 may have the at least one track 104, whereby the vehicle 101 may be contemplated as a tracked vehicle. The vehicle 101 may have another track (not viewable here), and thus two tracks (or more), as understood by one of skill. The track(s) 104 may be configured to facilitate movement of the vehicle 101.

The vehicle may have a driver or hub 105. The hub 105 may be contemplated as a final drive, and thereby configured to convert power into looping rotation of the track 104. The hub 105 may have one or more surfaces (e.g., teeth 107) configured to engage and move the track 104. The hub 105 may be operably coupled with the main frame 130, and configured for engagement and (looping) rotation of the at least one track 104. Another hub 105a may be passive, and thus facilitate the movement of the track 104. The other side of the vehicle may have respective or duplicate hubs and corresponding structure (not shown here).

The track frame 116 may be associated with the main frame 130 and proximate to the set of hubs 105, 105a. The track frame 116 may include the outer track frame portion 116b and the inner track frame portion 116a. The portions 116a and 116b may be (longitudinal) elongated in nature between the hubs 105, 105a.

The debris deflection device 102 may be coupled with the track frame 116. The debris deflection device 102 may have a first or inner panel 108 and/or a second or outer panel 110. In aspects, the panels may be coupled together via one or fasteners 128, such as nuts/bolts, weld, or the like. Either or both of the panels 108, 110 may have respective telescoping panels (208a, 210a). Another debris deflection device 102a may be installed on any other track akin to the manner described herein for the device 102 and as would be apparent to one of skill in the art.

The inner panel 108 may have a bottom inner panel end 150b, which may be elongated. The inner panel 108 may also have a top inner panel end 150, which may also be elongated. Analogously, the outer panel 110 may have a bottom outer panel end 151b, which may be elongated. The outer panel 110 may have a top outer panel end 151a, which may also be elongated.

In use, the bottom inner panel end 150b may be coupled with the inner track frame portion 116a, such as at coupling point 128a. Similarly, the bottom outer panel end 151b may be coupled with the inner track frame portion 116b, such as at coupling point 128b. The top inner panel end 150a may be coupled with the top outer panel end 151, such as via coupling point 119. There may be a plurality of coupling points 119. The configuration of the panels 108, 110 may result in formation of the edge or crest 120.

In aspects, operation vehicle 101 at any given moment in time provides the upper track portion 104a and the lower track portion 104b, whereby the device crest 120 may be proximate the upper track portion 104a.

Referring now to FIGS. 2A, 2B, and 2C together, a simplified schematic view of a panel for use with a debris deflector device, a simplified schematic view of another panel for use with a debris deflector device, and a lateral cross-sectional view of a debris deflector device, respectively, illustrative of embodiments disclosed herein, are shown.

FIGS. 2A-2C together show a debris deflector device 202 that may have one or more components or subcomponents associated therewith, one or any of which may be integral to another or separate as shown here. The device 202 may be like that of other devices described herein (e.g., 102, etc.), with similarities and differences being discernable to one of ordinary skill in the art. For the sake of brevity, the device 202 may not be described in all detail.

The device 202 may be suitable for use with an industrial or comparable type vehicle (101) where it may be desirous to move, deflect, etc. debris from accumulating in undesired areas of the vehicle. The device 202 may be elongated shape, such that it installs or otherwise fits within a frame of the vehicle, with proximity to a track. Any track may have a respective device 202. Any device may be, but need not be, similar or identical to another.

As shown here, the device 202 may have a first or inner panel 208, and a second or outer panel 210. The panels 208, 210 may be integral or coupled to each other in such a way that the device forms a device suitable for the deflection of debris (e.g., pointed or crested). Coupling of the panels 208, 210 may result in forming an apex (point) or crest 220.

To facilitate coupling with the vehicle, the panels 208, 210 may have respective top and bottom edges or sides 250 a,b and 251 a,b configured with mating features 219 a,b. For example, there may be holes or slots for fitting fasteners (screws, nails, bolts, etc.). Other ways of attachment may be chemical or physical, such as weld or adhesive, and combinations thereof. In aspects, the device 202 may couple with one or more weld points associated with the vehicle frame.

The device 202 may be configured with one or more adjustable (telescoping) panels. For example, the first panel 208 may have a first telescoping panel 208a. In a similar manner, the second panel 210 may have a respective telescoping panel 210a. Either of the panels 208, 210 may be configured with an irregular shape or cutout 242, whereby the panel more readily installs around a frame obstruction (117, FIG. 1F) or other structure not readily removed or repositioned.

### Advantages

Advantages of embodiments herein may enhance productivity and profitability altering the downtime to fix debris-inhibited equipment and alleviate the need for maintenance. The debris deflector device and related methods herein may reduce operational downtime for vehicles due to clogged tracks. The device may be used to divert, deflect, syphon away, etc. dirt, mud, and debris from the rotating tracks on allowing the vehicle.

Embodiments herein may advantageously resolve operational issues for unclogging the tracks of heavy equipment and vehicles. In doing so, this lowers the cost of the operator time for the owner, reduces extra fuel needs for extricating and moving other equipment to assist in the cleaning process. It further allows for equipment life to be increased due to less friction and also less possible damage when manually extricating debris. Other advantages may provide an improved ability for drivers/operators to continue work with less shutdown time related to debris removal. This also mitigates damage issues while operators are not digging, chipping and possibly hosing away material from the tracks causing possible damage.

While preferred embodiments of the disclosure have been shown and described, modifications thereof may be made by one skilled in the art without departing from the spirit and teachings of the disclosure. The embodiments described herein are exemplary only and are not intended to be limiting. Many variations and modifications of the embodiments disclosed herein are possible and are within the scope of the disclosure.

Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the present disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural, or other details supplementary to those set forth herein.

What is claimed is:

1. A tracked vehicle comprising:
a main frame;
an at least one track configured to facilitate movement of the tracked vehicle;
a set of hubs operably coupled with the main frame, and configured for engagement and rotation of the at least one track;
a track frame associated with the main frame and proximate to the set of hubs, the track frame comprising an outer track frame portion and an inner track frame portion; and
a debris deflection device coupled with the track frame.

2. The tracked vehicle of claim 1, wherein the debris deflection device further comprises:
an inner panel coupled with an outer panel.

3. The tracked vehicle of claim 2, wherein at least one of the inner panel and the outer panel comprise a telescoping panel movably coupled therewith.

4. The tracked vehicle of claim 2, wherein the inner panel has a bottom inner panel end coupled with the inner track frame portion, wherein the outer panel has a bottom outer panel end coupled with the outer track frame portion.

5. The tracked vehicle of claim 4, wherein the inner panel has a top inner panel end, and the outer panel has a top outer panel end, and wherein the top inner panel end and the top outer panel end are engaged together to form a device crest.

6. The tracked vehicle of claim 5, wherein during operation the at least one track comprises at a moment in time an upper track portion and a lower track portion, and wherein the device crest is proximate the upper track portion.

7. The tracked vehicle of claim 4, wherein the inner panel and the outer panel are each solid body components.

8. The tracked vehicle of claim 7, wherein at least one of a tensioner piston, a sprocket, an idler, and combinations thereof, is disposed within the track frame between the set of hubs, and underneath the debris deflection device.

9. The tracked vehicle of claim 1, the tracked vehicle further comprising:
a second track configured to facilitate movement of the tracked vehicle;
a second set of hubs operably coupled with at least one of an another side of the main frame, the first set of hubs, and combinations thereof, and the second set of hubs configured for engagement and rotation of the second track;
a second track frame associated with the main frame and proximate to the second set of hubs; and
a second debris deflection device coupled with the second track frame.

10. A tracked vehicle comprising:
a main frame;
an at least one track configured to facilitate movement of the tracked vehicle;
a set of rotating members operably coupled with the main frame, and configured for engagement and rotation of the at least one track;
a track frame associated with the main frame and in proximity to the set of rotating members, the track frame comprising an outer track frame portion and an inner track frame portion; and
a debris deflection device coupled with the track frame, the debris deflection device comprising an inner panel and an outer panel;
wherein at least one of the set of rotating members is powered, and
wherein at least one of the inner panel and the outer panel comprise a telescoping panel movably coupled therewith.

11. The tracked vehicle of claim 10, wherein the inner panel has a bottom inner panel end coupled with the inner track frame portion, wherein the outer panel has a bottom outer panel end coupled with the outer track frame portion.

12. The tracked vehicle of claim 11, wherein the inner panel has a top inner panel end, and the outer panel has a top outer panel end, and wherein the top inner panel end and the top outer panel end are engaged together to form a device crest.

13. The tracked vehicle of claim 12, wherein during operation the at least one track comprises at a moment in time an upper track portion and a lower track portion, and wherein the device crest is proximate the upper track portion.

14. The tracked vehicle of claim 13, wherein the inner panel and the outer panel are integral to each other.

15. The tracked vehicle of claim 13, wherein at least one of a tensioner piston, a sprocket, an idler, and combinations thereof, is disposed within the track frame between the set of rotating members, and underneath the debris deflection device.

16. The tracked vehicle of claim 10, the tracked vehicle further comprising:
a second track configured to facilitate movement of the tracked vehicle;
a second set of rotating members operably coupled with at least one of an another side of the main frame, the first set of rotating members, and combinations thereof, and the second set of rotating members configured for engagement and rotation of the second track;
a second track frame associated with the main frame and proximate to the second set of rotating members; and
a second debris deflection device coupled with the second track frame.

17. A tracked vehicle comprising:
a main frame;
an at least one track configured to facilitate movement of the tracked vehicle;
a set of hubs operably coupled with the main frame, and configured for engagement and rotation of the at least one track;
a track frame associated with the main frame and proximate to the set of hubs, the track frame comprising an outer track frame portion and an inner track frame portion; and
a debris deflection device coupled with the track frame,
wherein the debris deflection device further comprises: an inner panel and an outer panel,
wherein the inner panel has a bottom inner panel end coupled with the inner track frame portion, and
wherein the outer panel has a bottom outer panel end coupled with the outer track frame portion.

18. The tracked vehicle of claim 17, wherein the inner panel has a top inner panel end, and the outer panel has a top outer panel end, and wherein the top inner panel end and the top outer panel end are engaged together to form a device crest.

19. The tracked vehicle of claim 18, wherein during operation the at least one track comprises at a moment in time an upper track portion and a lower track portion, and wherein the device crest is proximate the upper track portion, and wherein at least one of a tensioner piston, a sprocket, an idler, and combinations thereof, is disposed within the track frame between the set of hubs, and underneath the debris deflection device.

20. The tracked vehicle of claim 19, the tracked vehicle further comprising:
a second track configured to facilitate movement of the tracked vehicle;
a second set of hubs operably coupled with at least one of an another side of the main frame, the first set of hubs, and combinations thereof, and the second set of hubs configured for engagement and rotation of the second track;
a second track frame associated with the main frame and proximate to the second set of hubs; and
a second debris deflection device coupled with the second track frame.
